(19) United States
(12) Patent Application Publication
(10) Pub. No.: US 2004/0249116 A1
(43) Pub. Date: Dec. 9, 2004

(54) Hydroxy-functional esters having terminal acrylate-functional groups

(76) Inventors: Aarnout C. Rouw, Buhl (DE); Heiko Fett, Gernbach (DE); Marvin Dettloff, Lake Jackson, TX (US); Marty J. Null, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/488,720

(22) PCT Filed: Sep. 10, 2002
(86) PCT No.: PCT/US02/28947

Related U.S. Application Data
(60) Provisional application No. 60/318,916, filed on Sep. 12, 2001.

(51) Int. Cl. C08F 2/46

(52) U.S. Cl. 528/320; 522/179; 428/500

(57) ABSTRACT

The present invention provides hydroxy-functional esters having at least one terminal acrylate-functional group. Preferred esters include those represented by the following formula (1): wherein each R¹ independently represents a substituted or unsubstituted aliphatic group; R represents hydrogen or methyl; a represents an integer of 0 to 5; b represents an integer of 0 to 5; a+b=at least 1; c represents an integer of 0 to 3; and A represents an alkylene, heteroalkylene, or arylene segment.

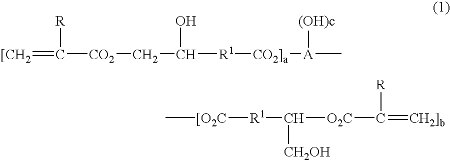

### FIELD OF INVENTION

The present invention relates to hydroxy-functional esters having terminal acrylate-functional groups. The invention further relates to processes for making the present esters, to compositions comprising the present esters, and to products obtained by curing these compositions.

### BACKGROUND OF THE INVENTION

Hydroxyfunctional esters having acrylate-functional groups along their side chains, such as certain acrylated epoxidized vegetable oils, are known. Examples of such components include, for instance, acrylated epoxidized linseed oil (for example, the commercial compound PHOTOMER 3082 from Cognis Corp.) and acrylated epoxidized soybean oil (for example, the commercial compound PHOTOMER 3005 from Cognis Corp.).

However, these conventional acrylate- and hydroxy-functional esters have relatively low reactivity, resulting in often long reaction times. While not wishing to be bound by any theory, it is believed that this low reactivity is due to the fact that the acrylate groups are internal instead of terminal, that is the acrylate groups are present along the side chains of the esters and not at the ends of the chains.

Also, the mechanical properties, and in particular the impact strength, of objects obtained by curing compositions comprising these conventional internally acrylated esters are comparatively poor, thereby making these compositions unsuitable for a wide variety of applications. Furthermore, these conventional internally acrylated esters tend to exhibit undesirably high viscosities.

It is an object of the present invention to provide acrylate- and hydroxy-functional esters having improved reactivity.

It is an object of the present invention to provide acrylate- and hydroxy-functional esters having a comparatively low viscosity.

In addition, it is an object of the present invention to provide compositions comprising an acrylate- and hydroxy-functional ester, whereby the compositions, after cure, have improved mechanical properties, for example, improved impact strength, over internally acrylated epoxy esters.

### SUMMARY OF THE INVENTION

The present invention provides esters that comprise at least one hydroxy group and at least one, preferably at least two, and more preferably at least three terminal acrylate-functional groups, for example, terminal (meth)acrylate groups. Preferably the number of hydroxy groups is equal to or greater than the number of terminal acrylate-functional groups.

In addition, the present invention provides processes for making the present esters. Processes that are provided include processes comprising reacting, in the optional presence of a catalyst,

(i) a component comprising an ester linkage and one or more terminal epoxy groups;

with

(ii) an alpha-beta unsaturated carboxylic acid.

Furthermore, the present invention provides compositions comprising the present esters and articles obtained by curing these compositions.

### DETAILED DESCRIPTION OF THE INVENTION

In this application, the term “ester” refers to a component comprising at least one ester linkage, preferably at least two, more preferably three ester linkages in addition to any ester linkages that comprise the CO₂ unit of an acrylate-functional group. The term “(meth)acrylate” is understood herein to include an acrylate and/or methacrylate.

The present esters are hydroxy-functional and comprise at least one, preferably at least two, more preferably three terminal acrylate-functional groups. Preferred acrylate-functional groups include (meth)acrylate groups. The amount of hydroxy groups in the present esters is preferably equal to or greater than, more preferably equal to, the amount of acrylate-functional groups.

Preferred esters according to the present invention include those represented by the following formula (1):

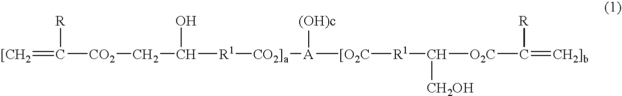

wherein

each R¹ independently represents a substituted or unsubstituted aliphatic group. R¹ may include heteroatoms (that is atoms other than carbon and hydrogen), but preferably R¹ represents a hydrocarbon group (that is preferably R¹ consists essentially of hydrogen and carbon atoms). Preferably all R¹ groups are identical;

each R independently represents hydrogen or methyl. Preferably each R represents hydrogen;

a represents an integer of 0 to 5, preferably 0 to 3;

b represents an integer of 0 to 5, preferably 0 to 3;

c represents an integer of 0 to 3, preferably 0 to 2, more preferably 0 to 1, most preferably 0;

a+b=at least 1, preferably at least 2, more preferably 3 to 4, most preferably 3;

a+b+c=preferably 3 to 4, more preferably 3; and

A represents an alkylene, heteroalkylene, or arylene segment. Examples of A include, for instance, residues selected from neopentylglycol residues, trimethylolethane residues, trimethylolpropane residues, pentaerythritol residues, and glycerol residues.

Preferred examples of A include groups represented by the following formula (2) or (3):

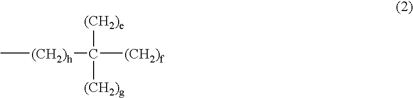

wherein

e, f, g, and h each independently represent an integer of 1 to 10, preferably 1 to 3, most preferably 1 to 2, most preferably 1; Preferably each e, f, g, and h represents 1.

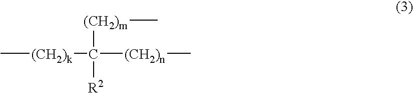

wherein

k and m independently represent an integer of 1 to 10, preferably 1 to 3, more preferably 1 to 2, most preferably 1;

n represents an integer of 0 to 10, preferably 0 to 3, more preferably 0 to 1, most preferably 0; and

R² represents hydrogen or a group represented by the following formula (4):

CH₃—(CH₂)ⱼ— (4)

wherein j represents an integer of 0 to 10, preferably 0 to 3, more preferably 0 to 1, most preferably 1. Preferably R² represents hydrogen.

Preferably A is represented by the above formula (3). More preferably, A is represented by the above formula (3) with k and m each representing 1, n representing 0, and R² representing hydrogen.

Preferably, each R¹ in the above formula (1) is independently selected from moieties represented by the following formulae (5) and moieties represented by the following formula (6):

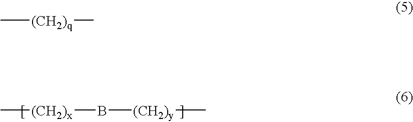

wherein

q represents an integer of 1 to 40, preferably 1 to 20, more preferably 5 to 15, most preferably 8 to 15;

x represents an integer of 0 to 20, preferably 1 to 15, more preferably 3 to 15, most preferably 5 to 15;

y represents an integer of 0 to 20, preferably 1 to 15, more preferably 3 to 15, most preferably 5 to 15;

x+y is an integer of 0 to 40, preferably 2 to 30, more preferably 5 to 25, most preferably 10 to 25;

z represents an integer of 1 to 4, preferably 1 to 2, more preferably z is 1; and

B represents sulfur, oxygen, carboxylate, nitrogen, amide, or an epoxy represented by the following formula (7):

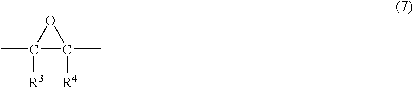

wherein R³ and R⁴ independently represent hydrogen or a moiety represented by the following formula (8):

CH₃—(CH₂)ₚ— (8)

wherein p represents an integer of 0 to 20, preferably from 1 to 10, more preferably from 1 to 5.

Preferably B is represented by formula (7).

Preferably all R¹ groups are either all represented by formula (5) or all represented by formula (6). More preferably all R¹ groups are represented by formula (5). The present acrylate- and hydroxy-functional esters may be prepared by reacting alpha-beta unsaturated carboxylic acids with components comprising an ester linkage and at least one terminal epoxy group. Preferred alpha-beta unsaturated carboxylic acids include acrylic acid and methacrylic acid. Preferred epoxy components include triacylglycerides comprising one or more terminal epoxy-groups. Preferred epoxy-functional triacylglycerides include those represented by the following formula (9):

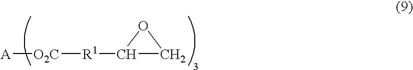

wherein R¹ is as defined above and A is represented by the above formula (3).

Particularly preferred epoxy-functional triacylglycerides include 10,11-epoxyundecenoyl triglyceride and 9,10-epoxydecenoyl triglyceride.

Other suitable epoxy-functional components that may be used to prepare acrylate-functional esters according to the present invention include those described in WIPO Publication 00/18571.

The component comprising an ester linkage and one or more terminal epoxy groups may be reacted with the alpha-beta unsaturated carboxylic acid in the presence of a suitable catalyst. Suitable catalysts include, for instance, triphenylphosphine, tertiary amines [for example, dimethylamines, for instance benzyldimethylamine and tris(dimethylaminomethyl)phenol], metal alkoxides [for example, titanium(IV) butoxide], tetraalkyl ammonium halides [for example, tetramethylammonium chloride and tetrabutylammonium bromide], and chromium(III) salts [such as chromium(III) halides, for instance chromium(III) chlorides, for example, Cr(III)Cl_{3.}6H₂O], and mixtures of these catalysts. Preferred catalysts include chromium(III) halide salts and tetraalkylammoniumhalides. Preferred reaction temperatures for acrylating the epoxidized triacylglycerides include 70° C. to 130° C., more preferably 85° C. to 120° C. A particularly preferred range for reactions using tetraalkylammonium salts is 80° C. to 90° C. A particularly preferred range for reactions using chromium(III) salts is 110° C. to 120° C.

Preferred acrylate- and hydroxy-functional esters according to the present invention include those having a kinematic viscosity, as measured with a Cannon-Fenske kinematic viscosity tube at 25° C. according to ASTM D-445, of below 10,000 cP, more preferably below 7,000 cP, and most preferably below 5,000 cP. Preferably the viscosity of the present acrylate- and hydroxy-functional esters is at least 1,000 cP, more preferably at least 2,000 cP at 25° C.

Preferably the molecular weight of the present acrylate- and hydroxyfunctional esters is at least 400 g/mol, more preferably at least 600 g/mol. Preferably the molecular weight of the present acrylate- and hydroxyfunctional esters is less than 2000 g/mol, more preferably less than 1500 g/mol, most preferably less than 1200 g/mol.

The present acrylate- and hydroxy-functional esters are advantageously used in a variety of compositions. Such compositions may comprise, besides one or more of the present esters, any further suitable reactive components such as, for instance, epoxy-functional components, additional acrylate-functional components, further hydroxy-functional components, as well as mixtures thereof. Preferably the compositions comprise, besides one or more of the present esters, at least one further acrylate-functional component, such as for instance tripropylene glycol diacrylate or hexanediol diacrylate.

The compositions of the present invention may further comprise any suitable additives, such as inorganic fillers (for example, glass, silica, clays, and talc), stabilizers (for example, antioxidants), pigments, rheology control agents, photoinitiators, etc.

The present compositions may be cured by heat and/or radiation, for instance by ultraviolet (UV) radiation. If UV radiation is used, it is preferred to include one or more photoinitiators in the present compositions. Photoinitiators are known in the art. Commercial examples include, for instance, IRGACURE 184 and IRGACURE 651 from Ciba Geigy.

Preferably, compositions containing the present acrylate- and hydroxy-functional esters comprise, relative to the total weight of the composition, at least 1 weight percent (wt. %) of the present esters, more preferably at least 10 wt. %, and even more preferably at least 30 wt. %. Preferably the present compositions comprise, relative to the total weight of the composition, less than 99 wt. % of the present esters, more preferably less than 80 wt. %.

Preferred compositions according to the present invention include those having, after cure, a direct impact strength, as measured according to ASTM 2794-93, of at least 85 lbs·in (97.9 kg·cm), more preferably at least 90 lbs·in (103.7 kg·cm), and most preferably at least 95 lbs·in (109.5 kg·cm). Preferred compositions according to the present invention further include those having, after cure, a reverse impact strength, as measured according to ASTM 2794-93, of at least 25 lbs·in (28.8 kg·cm), more preferably at least 30 lbs·in (34.6 kg·cm).

Applications

Compositions comprising the present acrylate- and hydroxy-functional esters are useful in a wide variety of applications. For instance, they are useful in coatings, in matrix materials for composites (for example, for composites that are reinforced with fibers such as polyamide-, glass-, polyester-, or naturally occurring fibers), in adhesives, and in molded parts.

### EXAMPLES

The following examples are given as particular embodiments of the invention and to demonstrate the practice and advantages thereof. It is to be understood that the examples are given by way of illustration and are not intended to limit the specification or the claims that follow in any manner.

Preparation of Undecenoyl Triglyceride

442.3 g of undecylenic acid (0.67 mole), 61.4 g of glycerol (0.8 mole), and 160 mL of toluene were charged into a 1 L glass reactor equipped with an electrical heating unit, a temperature controller, a condenser, and a Dean Stark water trap. 8.9 g of p-toluenesulfonic acid esterification catalyst was added and the temperature of the reaction mixture was increased to 130° C. to 140° C., where the onset of the esterification reaction resulted in reflux of toluene and the separation of water. The esterification and water separation was continued over a period of 2 to 2.5 hours while gradually increasing the temperature to a maximum of 160° C. This resulted in removal of about 90% of the theoretical amount of water from the esterification reaction.

The dark brown end product was transferred to a separatory funnel and twice washed with a saturated sodium bicarbonate and three times with a saturated aqueous sodium chloride solution. The organic layer was collected and dried overnight over anhydrous sodium sulphate/calcium chloride. The residual toluene was removed under vacuum, after which a light brown organic product (undecenoyl triglyceride) was obtained.

Iodometric titration (according to ASTM D 5554-95) demonstrated the thus obtained triacylglyceride to have an iodine value of 117.3 (theoretical value 128.8).

Preparation of 10,11-epoxy-undecanoyl triglyceride

64 g of the above obtained undecenoyl triglyceride (0.11 mole) and 128 g of chloroform were transferred into a 0.5 L glass reactor. This reactor was equipped with a stirrer, a thermostatted water bath and a condenser. 76 g of peracetic acid (39% in acetic acid; obtained from Aldrich) [0.39 Eq, 1.2 moles of peracetic acid per 1 mole of double bonds in the undecenoyl triglyceride] was placed in a dropping funnel. Under stirring, the reactor content was heated to 40° C. The mixture of peracetic acid and acetic acid was gradually added to the reactor content over a period of 60 min. Care was taken to adjust the addition speed to keep the temperature of the reactor below 50° C. After addition of this mixture, the stirring of the reactor was continued for 180 min. at a temperature of 55° C. Subsequently, 200 mL of a 10 wt. % aqueous solution of sodium sulphite was added to the reactor to destroy any left over peracetic acid. Care was taken to add the 10 wt. % solution slowly to ensure that the temperature would not exceed 58° C. Then, the reactor content was transferred to a separatory funnel and neutralized by the addition of a saturated aqueous solution of sodium bicarbonate. After separation, the aqueous phase of the resulting mixture was discarded. The remaining organic phase was washed three times with an equal volume of a water/isopropanol mixture (70/30 ratio by weight), and each time the aqueous phase was removed after washing. The resulting yellow colored organic product was dried over sodium sulphate and transferred to a 1 L rotary evaporator flask, and the chloroform present in the organic product was stripped of under vacuum to yield 10,11-epoxy-undecanoyl-triglyceride (hereinafter also referred to as “the tris-epoxy”). The epoxy content of the tris-epoxy was determined and found to be 16.9% (85% of the theoretical value), and the iodine value turned out to be 2.6. The viscosity of the tris-epoxy at 25° C., as measured according to ASTM D-445, was 125 cSt.

### Example 1

120 g (0.47 Eq) of the tris-epoxy prepared above was transferred into a 0.5 L glass reactor equipped with a temperature controller, a heating jacket, a reflux condenser and an inlet for air. To the reactor were added 0.06 g of hydroquinone inhibitor and 34 g of acrylic acid (0.47 Eq). Under stirring and slow air sparge, the reactor content was heated to 110°C. At this temperature 0.12 g of tris(dimethylaminomethyl)phenol and 0.14 g of a 33 wt. % aqueous solution of Cr(III)Cl₃.6H₂O was added to the reactor. The reaction was continued at 120° C. until the epoxy content had dropped below 1.5% (which occurred after about 9 hours. At this point the acid content was 1.2%. The yellow-brown end product had a kinematic viscosity at 25° C. of 8700 cP.

### Example 2

120 g (0.52 Eq) of a tris-epoxy similar to the tris-epoxy used in Example 1 (differences: epoxy content is 18.8% instead of 16.9%, iodine value is 0.05 instead of 2.6) was transferred into a 0.5 L glass reactor equipped with a temperature controller, a heating jacket, a reflux condenser and an inlet for air. To the reactor were added 0.06 g of hydroquinone inhibitor and 28.3 g of acrylic acid (0.39 Eq), as well as 0.12 g of triphenylphosphite. Under stirring and slow air sparge, the reactor contents was heated to I10° C. At this temperature, 0.12 g of tris(dimethylaminomethyl)phenol and 0.14 g of a 33 wt. % aqueous solution of Cr(III)Cl₃.6H₂O was added to the reactor. The reaction was continued at 120° C. until the epoxy content had dropped to 0.8% (which occurred after about 6 hours.). At this point the acid content was 1.2%. The yellow-brown end product was stored for further use.

### Example 3

60 g (0.27 Eq) of a tris-epoxy similar to the one used in Example 1 (difference: epoxy content is 19.8% instead of 16.9%) was transferred into a 0.25 L glass reactor equipped with a temperature controller, a heating jacket, a reflux condenser and an inlet for air. To the reactor were added 0.20 g of 4-methoxyphenol inhibitor and 0.6 g of a 4 wt. % solution of chromium(III)chloride hexahydrate in acrylic acid. Under stirring and an air sparge, the reactor contents was heated to 120° C., after which 21.5 g of acrylic acid (0.30 Eq) was slowly added. The reaction was continued at 120° C. until the epoxy content had reached 0.9%, which occurred after about 4 hours. At this point the acid content was determined as 0.3%. The slightly pale-greenish product had a kinematic viscosity of at 25° C. of 3560 cP.

### Example 4

120 g (0.52 Eq) of a tris-epoxy corresponding to the tris-epoxy used in Example 1 was transferred into a 0.5 L glass reactor equipped with a temperature controller, a heating jacket, a reflux condenser and an inlet for air. To the reactor were added 0.06 g of hydroquinone inhibitor and 31.3 g of acrylic acid (0.43 Eq), as well as 0.12 g of triphenylphosphite. Under stirring and slow air sparge, the reactor contents was heated to 110° C. At this temperature 0.12 g of tris(dimethylaminomethyl)phenol and 0.14 g of a 33 wt. % aqueous solution of Cr(Di)Cl₃-6H₂0 was added to the reactor. The reaction was continued at 120° C. until the epoxy content had dropped to 1.2%, which occurred after about 10 hours. At this point the acid content was 2.0%. The yellow-brown end product was stored for further use.

### Example 5

25 g (0.109 Eq) of a tris-epoxy similar to the one in Example 1 was transferred to a 100 mL glass reactor equipped with an air sparger, a reflux condenser, heating mantle, temperature controller and a TEFLON (polytetrafluoroethylene)-coated magnetic stir bar. To the reactor was added 8.26 g (0.115 Eq) of acrylic acid, 0.090 g (0.00026 Eq) titanium(IV) butoxide, 0.083 g (0.0008 Eq) triethylamine and 0.009 g (0.00007 Eq) 4-methoxyphenol. With constant stirring and sub-surface air sparge, the reactor contents were heated to 85° C. The reaction was continued at 85° C. until the epoxy content was below 1.5%, which occurred after about 13 hours. The reactor content was then dissolved in chloroform and washed with deionized water to a neutral pH in order to remove the excess acrylic acid. The organic layer was dried over magnesium sulfate. The chloroform was stripped off under vacuum. The yellow oil end product had an epoxy content of 1.00% and a viscosity of 9340 cP at 25° C.

### Example 6

20 g (0.092 Eq) of a tris-epoxy similar to the one used in Example 1 (difference: epoxy content is 19.73% instead of 16.9%) was transferred to a 100 mL glass reactor equipped with an air sparger, a reflux condenser, heating mantle, temperature controller and a TEFLON (polytetrafluoroethylene)-coated magnetic stir bar. To the reactor was added 6.94 g (0.096 Eq) of acrylic acid, 0.0813 g (0.00060 Eq) benzyldimethylamine, and 0.0164 g (0.00013 Eq) 4-methoxyphenol. With constant stirring and sub-surface air sparge, the reactor contents were heated to 85° C. The reaction was continued at 85° C. until the epoxy content was below 1.5%, which occurred after about 19 hours. The reactor content was then dissolved in chloroform and washed with deionized water to a neutral pH in order to remove the excess acrylic acid. The organic layer was dried over magnesium sulfate. The chloroform was stripped off under vacuum. The very light yellow oil had an epoxy content of 1.44% and a viscosity of 4962 cP at 250C.

### Example 7

20 g (0.092 Eq) of a tris-epoxy corresponding to the tris-epoxy used in Example 6 was transferred to a 100 mL glass reactor equipped with an air sparger, a reflux condenser, heating mantle, temperature controller and a TEFLON (polytetrafluoroethylene)-coated magnetic stir bar. To the reactor was added 6.95 g (0.096 Eq) of acrylic acid, 0.067 g (0.00061 Eq) tetramethylammonium chloride, and 0.0145 g (0.00012 Eq) 4-methoxyphenol. With constant stirring and sub-surface air sparge, the reactor contents were heated to 85° C. The reaction was continued at 85° C. until the epoxy content was below 1.5%, which occurred after about 14 hours. The reactor content was then dissolved in chloroform and washed with deionized water to a neutral pH in order to remove the excess acrylic acid. The organic layer was dried over magnesium sulfate. The chloroform was stripped off under vacuum. The very light yellow clear oil had an epoxy content of 1.44% and a viscosity of 4227 cP at 25° C.

### Example 8

20 g (0.092 Eq) of a tris-epoxy corresponding to the tris-epoxy used in Example 6 was transferred to a 100 mL glass reactor equipped with an air sparger, a reflux condenser, heating mantle, temperature controller and a TEFLON (polytetrafluoroethylene)-coated magnetic stir bar. To the reactor was added 6.96 g (0.096 Eq) of acrylic acid, 0.190 g (0.00059 Eq) tetrabutylammonium bromide, and 0.0146 g (0.00012 Eq) 4-methoxyphenol. With constant stirring and sub-surface air sparge, the reactor contents were heated to 85° C. The reaction was continued at 85° C. until the epoxy content was below 1.5%, which occurred after about 7 hours. The reactor content was then dissolved in chloroform and washed with deionized water to a neutral pH in order to remove the excess acrylic acid. The organic layer was dried over magnesium sulfate. The chloroform was stripped off under vacuum. The very light yellow clear oil had an epoxy content of 0.37% and a viscosity of 5318 cP at 25° C. The product was stored for further use.

### Example 9

20 g (0.092 Eq) of a tris-epoxy similar to the tris-epoxy used in Example 1 (difference: epoxy content is 19.87% instead of 16.9%) was transferred to a 100 mL glass reactor equipped with an air sparger, a reflux condenser, heating mantle, temperature controller and a TEFLON (polytetrafluoroethylene)-coated magnetic stir bar. To the reactor was added 7.44 g (0.1032 Eq) of acrylic acid, 0.075 g (0.00069 Eq) tetramethylammonium chloride, and 0.0156 g (0.00013 Eq) 4-methoxyphenol. Under constant stirring and sub-surface air sparge, the reactor contents were heated to 85° C. The reaction was continued at 85° C. until the epoxy content was below 1.5%, which occurred after about 7 hours. The reactor content was then dissolved in chloroform and washed with deionized water to a neutral pH in order to remove the excess acrylic acid. The organic layer was dried over magnesium sulfate. The chloroform was stripped off under vacuum. The very light yellow clear oil had an epoxy content of 0.53% and a viscosity of 5062 cP at 25° C.

The viscosities of acrylated epoxy-undecanoyl-triglycerides prepared in Examples described above are summarized in the following Table 1. Viscosities of certain commercial components are added as a comparison.

TABLE 1

| Example | Viscosity at 25° C. (cP) |
|---|---|
| 1 | 8700 |
| 3 | 3560 |
| 5 | 9340 |
| 6 | 4962 |
| 7 | 4227 |
| 8 | 5318 |
| 9 | 5062 |
| Commercial Components: | |
| PHOTOMER 3005 (acrylated soybean oil | 13000-20000 |
| from Cognis Corp.) | |
| PHOTOMER 3082 (acrylated linseed oil | 50000-150000 |
| from Cognis Corp.) | |
| EBECRYL 8402 (urethane acrylate, from | 11000 |
| UCB Chemicals Corp.) | |

### Example 10

37.5 g of the product prepared in Example 1 was mixed with 10.5 g of tripropyleneglycol diacrylate (TPGDA) diluent and with 1 g of IRGACURE 184 and 1 g of IRGACURE 651 photoinitiators (IRGACURE 184 and 651 are photoinitiators commercially available from Ciba-Geigy). The viscosity of the resulting mixture was measured with a Cannon-Fenske kinematic viscosity tube (ASTM D-445). At 25° C., a value of 3870 cSt was obtained. The liquid mixture was applied with a bar coater to several BONDER 26 phosphated steel panels. On a moving belt (1.5 m/min), the panel was moved along under a UV lamp (120 W/cm²), in order to initiate the curing process. Thickness of the final coating was in the range 30 to 45 microns. The coated panels were subjected to various coating tests, of which the results are listed in Table 2.

### Example 11

37.5 g of the product prepared in Example 3 was mixed with 10.5 g of Tripropyleneglycol diacrylate (TPGDA) diluent and with 1 g of IRGACURE 184 and 1 g of IRGACURE 651 photoinitiators (IRGACURE 184 and 651 are photoinitiators commercially available from Ciba-Geigy). The viscosity of the resulting mixture was measured with a Cannon-Fenske kinematic viscosity tube (ASTM D-445). The viscosity of the resulting mixture at 25° C. was 975 cSt.

### Example 12

Example 10 was repeated, except that the product prepared in Example 1 was replaced with 37.5 g of the product prepared in Example 4.

### Comparative Example A

Example 10 was repeated, except that the product prepared in Example 1 was replaced with 37.5 g of PHOTOMER 3005 (acrylated epoxidized soya bean oil, commercially available from Cognis Corp.). The kinematic viscosity of the resulting mixture at 25° C. was determined as 2133 cSt.

### Comparative Example B

Example 10 was repeated, except that the product prepared in Example 1 was replaced with 37.5 g of PHOTOMER 3082 (acrylated epoxidized linseed oil, commercially available from Cognis Corp.). The kinematic viscosity of the resulting mixture at 25° C. was determined as 4380 cSt.

### Comparative Example C

Example 10 was repeated, except that the product prepared in Example 1 was replaced with 37.5 g of EBECRYL 8402 (aliphatic urethane diacrylate, commercially available from UCB Chemicals Corp.). The kinematic viscosity of the resulting mixture at 25° C. was determined to be 1500 cSt.

### Comparative Example D

Example 10 was repeated, except that the product prepared in Example 1 was replaced with 37.5 g of EBECRYL 810 (polyesteracrylate, commercially available from UCB Chemicals Corp.). The kinematic viscosity of the resulting mixture at 25° C. was determined as 5178 cSt.

### Comparative Example E

Example 10 was repeated, except that the product prepared in Example 1 was replaced with 37.5 g of a Bisphenol A-epoxyacrylate. The kinematic viscosity of the resulting mixture at 25° C. was determined as 27250 cSt.

TABLE 2

| | | | Pendulum | Direct Impact | Reverse Impact | Mandrel | |
|---|---|---|---|---|---|---|---|
| | Acetone | | Hardness | Strength | Strength | flexibility | Crosshatch |
| | Double rubs | | sec | (lbs · in; kg · cm) | (lbs · in; kg · cm) | mm | adhesion |
| | (ASTM | Tg¹ | (ASTM | (ASTM | (ASTM | (ASTM | (ASTM |
| Example | 5402-93) | (° C.) | D4366-84) | 2794-93) | 2794-93) | D522-93) | D3359-97) |
| 10 | >100 | 35 | 91 | 100; 115.2 | 30; 34.6 | 5 | 2 |
| 12 | >100 | 39 | 107 | 140; 161.3 | 40; 46.1 | 5 | 1 |
| Comp. A | >100 | 39 | 90 | 80; 92.2 | 10; 11.5 | 5 | 1 |
| Comp. B | >100 | 44 | 126 | 80; 92.2 | 20; 23 | 10 | 2 |
| Comp. C | >100 | 34 | 141 | 160; 184.3 | 80; 92.2 | 2 | 4 |
| Comp. D | >100 | 48 | 183 | 80; 92.2 | 20; 23 | 16 | 1 |
| Comp. E | >100 | 57 | 350 | 40; 46.1 | <4; <4.6 | 32 | 0 |

¹Measured by differential scanning calorimetry (DSC) at a heating rate of 10 K/min.

Having described specific embodiments of the present invention, it will be understood that many modifications thereof will readily be apparent to those skilled in the art, and it is intended therefore that this invention is limited only by the spirit and scope of the following claims.

1. An ester comprising at least one hydroxy group and at least one terminal acrylate-functional group.

2. The ester of claim 1, wherein said ester has a molecular weight in the range of 600 to 1200 g/mol.

3. The ester of claim 1, wherein said ester has a viscosity below 10,000 cSt at 25° C.

4. The ester of claim 1, wherein the amount of hydroxy groups in said ester is equal to or greater than the number of acrylate-functional groups in said ester.

5. The ester of claim 1, wherein the amount of hydroxy groups in said ester is equal to the number of acrylate-functional groups in said ester.

6. The ester of claim 1, wherein said ester is represented by the following formula (1): 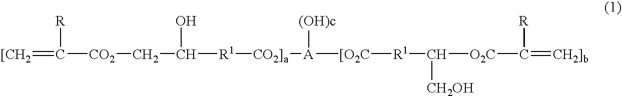
wherein
each R¹ independently represents a substituted or unsubstituted aliphatic group;
R represents hydrogen or methyl;
a represents an integer of 0 to 5;
b represents an integer of 0 to 5;
a+b=at least 1;
c represents an integer of 0 to 3; and
A represents an alkylene, heteroalkylene, or arylene segment.

7. The ester of claim 6, wherein a+b+c is 3.

8. The ester of claim 6, wherein said a+b is 3 and wherein c represents 0.

9. The ester of claim 6, wherein A is represented by the following formula (2) or by the following formula (3): 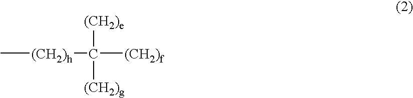
wherein
e, f, g, and h each independently represent an integer of 1 to 10; 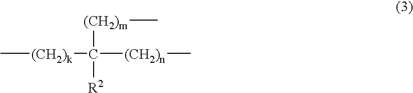
wherein
k and m independently represent an integer of 1 to 10;
n represents an integer of 0 to 10; and
R² represents hydrogen or a group represented by the following formula (4):
CH₃—(CH₂)ⱼ— (4)
wherein j represents an integer of 0 to 10.

10. The ester of claim 9, wherein A is represented by formula (2) and wherein e, f, g, and h each represent 1.

11. The ester of claim 9, wherein A is represented by formula (3), wherein k, m, and n each represent 1, wherein R² is represented by said formula (4), and wherein j represents 1.

12. The ester of claim 9, wherein A is represented by formula (3), wherein k and m each represent 1, wherein n represents 0, and wherein R¹ represents hydrogen.

13. The ester of claim 6, wherein R¹ represents a hydrocarbon group.

14. The ester of claim 6, wherein R¹ is represented by the following formula (5):
(CH₂)_{q}— (5)
wherein q represents an integer of 1 to 40.

15. The ester of claim 14, wherein q represents an integer of 8 to 15.

16. A process for preparing the ester of claim 1, comprising reacting
(i) an alpha-beta unsaturated carboxylic acid; with
(ii) an epoxy-functional component comprising an ester linkage and one or more terminal epoxy groups.

17. The process of claim 16, comprising reacting said alpha-beta unsaturated carboxylic acid with said epoxy-functional component at a temperature of 70° C. to 130° C.

18. The process of claim 16, comprising reacting said alpha-beta unsaturated carboxylic acid with said epoxy-functional component in the presence of a catalyst.

19. The process of claim 18, wherein said catalyst is a chromium(III) salt or a tetraalkylammonium halide.

20. A radiation-curable composition comprising the ester of claim 1.

21. The composition of claim 20, wherein said composition, after cure, has a direct impact strength of at least 85 lbs·in (97.9 kg·cm).

22. The composition of claim 20, wherein said composition, after cure, has a reverse impact strength of at least 25 lbs·in (28.8 kg·cm).

23. The composition of claim 20, wherein said composition comprises, relative to the total weight of the composition, at least 10 wt. % of said ester.

24. The composition of claim 20, further comprising an additional acrylate-functional compound.

25. The composition of claim 20, further comprising tripropyleneglycol diacrylate and/or hexanediol diacrylate.

26. An object formed at least in part by curing the composition of claim 20.

27. A substrate having a coating, said coating being obtained by curing the composition of claim 20.

28. A composite comprising a matrix material and a reinforcing material, said matrix material being obtained by curing the composition of claim 20.
